(19) United States
(12) Patent Application Publication
(10) Pub. No.: US 2024/0301195 A1
(43) Pub. Date: Sep. 12, 2024

(54) POLYMER RAW MATERIALS WITH REDUCED REACTIVITY FOR STORAGE-STABLE REACTIVE RESINS

(71) Applicant: Röhm GmbH, Darmstadt (DE)

(72) Inventors: Alexander Klein, Gau-Algesheim (DE); Janos Lotz, Gelnhausen (DE); Sybille Scholl, Rodenbach (DE); Ingrid Kizewski, Hanau (DE)

(73) Assignee: Röhm GmbH, Darmstadt (DE)

(21) Appl. No.: 18/252,546

(22) PCT Filed: Nov. 2, 2021
(86) PCT No.: PCT/EP2021/080291

§ 371 Date: May 11, 2023

(30) Foreign Application Priority Data
Nov. 12, 2020 (EP) 20207077.7

(51) Int. Cl. C08L 33/06

(52) U.S. Cl. CPC C08L 33/062; C08L 2205/025

(57) ABSTRACT

A process for preparing (meth)acrylate-based reactive resins involves mixing at least one polymer component and a monomer component. The reactive resins, especially (meth)acrylate resins, as are useful as a component, for example, in two-component systems employed as road marking, floor coating, or sealant. A particular feature of the new process is that its use can bring about increased product safety and stability both during preparation and during storage and transport.

### FIELD OF THE INVENTION

The field of the invention is the preparation of reactive resins, especially (meth)acrylate resins, as are used as component, for example, in two-component systems employed as road marking, floor coating or sealant. A particular feature of the new process is that its use can bring about increased product safety and stability both during preparation and during storage and transport.

### PRIOR ART

Numerous (meth)acrylate resins based on various concepts are known from the prior art. These can be used in a great variety of application fields, such as road markings, floor coatings, roof or bridge coatings, metal coating such as anticorrosion or intumescent coatings, and adhesives and sealants.

(Meth)acrylate resins are understood to be solutions of polymers such as poly(meth)acrylates, for example, in monomeric (meth)acrylic esters. They generally contain further additives and auxiliaries. An important constituent are the “activators”, which are also referred to as accelerators. These components trigger polymerization of the monomer fraction in the (meth)acrylate resin when initiators are added. The initiators for the curing of (meth)acrylate resins are added, for example, directly at the site of use, e.g. at a building site.

The components of the (meth)acrylate resins are generally not used immediately following their preparation, and therefore need to have sufficient storage stability over a relatively long period. To this end, after preparation they are often transported over long distances, up to and including as intercontinental maritime freight. A maximally high storage stability of (meth)acrylate resins, in particular even at high temperatures, is essential for quality reasons as well as from safety perspectives. Moreover, storage-stable (meth)acrylate resins of this kind make it possible to dispense with expensive temperature-controlled transport and temperature-controlled storage. Uncontrolled polymerization during preparation, transport or storage must therefore be avoided.

(Meth)acrylate resins are prepared in chemical plants typically by dissolving polymers, for example (meth)acrylate-based polymers, in (meth)acrylate monomer mixtures and optionally mixing with additives, accelerators and further additive substances. The procedure for dissolving the polymer and the mixing with the further feedstocks are typically effected at a temperature of between 40 and 70° C.

Preference is given to using polymer pellets or preferably suspension polymers, which are also referred to as bead polymers, in the reactive resin preparation. The advantage of the suspension polymers is that they in general have a small particle size, typically of less than 0.8 mm. Rapid dissolution of these small particles in the (meth)acrylate monomer mixtures can thus be ensured. Solid bulk polymers such as pellets must first be prepared in complex comminution processes in order to be usable in the reactive resin preparation.

Short-chain (meth)acrylic esters, such as methyl methacrylate, are highly flammable and even at low temperatures have sufficient vapour pressure to form an explosive atmosphere. In practice, therefore, production tanks in the preparation process of (meth)acrylate resins are blanketed with low-oxygen air or even pure protective gas, e.g. nitrogen. However, an atmosphere with a low oxygen content has negative effects on the stability of reactive resins. Oxygen has an inhibitory action on the polymerization reaction of (meth)acrylic esters, since the addition of oxygen onto a free-radical chain end takes place more rapidly than the addition of a monomer.

The (meth)acrylate-based polymers used during the reactive resin preparation are for their part prepared in separate suspension polymerization or bulk polymerization processes. In these processes, monomers are polymerized in a controlled manner using peroxides as initiators. In respect of bulk polymerization, helpful pointers can be found in Houben-Weyl, volume E20, part 2 (1987), page 1145 ff. Suspension polymerization is described in this document on page 1149 ff.

The suspension or bulk polymers prepared generally still contain residual proportions of peroxides. This residual content in the corresponding preparation processes is decisively determined by the peroxide used, the temperature level and hold time at the relevant temperatures. With respect to the preparation, transport and storage, what are critical in particular are residues of peroxides which for example within a temperature interval of 70 to 100° C. have a half-life of an hour. These peroxides can lead to uncontrolled polymerization at elevated temperatures, such as for example at 40 to 70° C. during the reactive resin preparation. During transport and storage, residues of such peroxides also decompose over time to give free radicals, which for their part can likewise trigger uncontrolled polymerization.

U.S. Pat. No. 2,833,753 does disclose that the residual peroxide content in commercially available acrylic polymers would usually not be sufficient to induce polymerization of added monomers at low temperature, e.g. below 50° C. However, no statements are made therein concerning the residual peroxide contents typically present in commercial products, and experience shows that a risk absolutely still remains.

DE 197 06 064 also discloses that commercial PMMA powders or suspension polymers can still include residual contents of active peroxide groups. These are given here using the example of dibenzoyl peroxide, with a range between 0.24 and 45 mg/g. This corresponds to 099 to 186 mmol/kg of peroxide in the polymer, and was determined by iodometric titration. Here too, no negative effects on the storage stability of monomer/polymer mixtures are expected with these residual contents.

When preparing the suspension polymers, the temperature level during the polymerization according to the prior art in DE 102009027620A1, using the example of initiation with lauroyl peroxide, is 65 to 90° C. After conclusion of the polymerization proper at a conversion of greater than 99% of the monomers used, the polymer is separated from the suspension and then dried in a drying process, for example in a fluidized bed.

In practice, such polymers still contain proportions of residual peroxide from the preparation, and these can present a significant residual risk of undesired polymerization when used to prepare reactive resins, in particular when inertizing the mixing tank.

In summary, it can be stated that, even if some documents of the prior art come to the conclusion that the risk posed by the residual proportions of peroxide in suspension polymers for the storage of (meth)acrylate-based reactive resins is extremely low, it should nevertheless be stated that in practice even this minimal risk can absolutely lead to defective batches and products that are no longer usable after storage.

### Objects

With regard to this prior art and practical experience, it was therefore an object of the present invention to further minimize the residual risk of unwanted polymerization when using polymer raw materials comprising residual peroxide contents in the preparation, and especially in the transport and storage, of (meth)acrylate resins.

It was an object in particular, when preparing the resins at elevated temperatures and on account of explosion protection requirements under low-oxygen gas phase, or in an inert gas atmosphere, to suppress unwanted, if even only partial, polymerization.

A further object was that of avoiding such polymerization of the reactive resins even when storing and/or transporting the individual components of the reactive resins in the event of the possible occurrence of elevated temperatures.

Therefore, it was a particular object of the present invention to provide a new (meth)acrylate-based reactive resin which even in the case of high requirements for explosion protection can be prepared in uniform quality and at the same time without the risk of premature polymerization, and likewise also has high storage stability after preparation, even at elevated temperatures.

Other objects not stated explicitly can be gathered from the prior art, the description, the examples or the overall context of the application.

### Achievement of Objects

The objects have been achieved by providing a novel process for preparing storage-stable (meth)acrylate-based reactive resins. In this process, at least one polymer component and a monomer component are mixed with one another under a gas phase with stirring, with at least 90% by weight, preferably at least 99% by weight, of the polymer component dissolving in the monomer component. The process is characterized in that the gas phase has an oxygen content of between 3% and 8% by volume. In addition, in this process the polymer component prior to mixing with the monomer component has a residual peroxide content of at most 0.375 mmol, preferably at most 0.25 mmol, of peroxide per kilogram.

The maximum amounts of peroxide correspond, e.g. in the case of lauroyl peroxide, for example to preferably at most approx. 150 ppm by weight, particularly preferably at most approx. 150 ppm by weight, of lauroyl peroxide.

Highly surprisingly, particularly storage-stable reactive resins can be prepared with this low peroxide content.

It has been found that the peroxide content can be reduced in the polymer preparation by a post-heating step. This additional post-heating step, which follows the polymerization proper, is conducted at the same or, preferably, at a higher temperature as/than the polymerization process proper, so that the amount of residual peroxide remaining is reduced to less than 0.375 mmol/kg of polymer.

For example, in bead polymerization using lauroyl peroxide (1-hour half-life temperature, at which 50% of the initiator has decomposed within 1 h, =79° C.) as initiator, the suspension prior to drying is heated preferably to a temperature that is at least 8° C. higher than the 1-hour half-life temperature and is held at this temperature level for at least 90 min. The residual peroxide content is reduced thereby to at most 0.375 mmol/kg in the polymer or 150 ppm of lauroyl peroxide. If the post-heating step is effected at at least 11° C. above the 1-hour half-life temperature of the initiator for at least 60 min, or at least 90 min, the residual peroxide content is reduced to at most 150 ppm, or 100 ppm, of lauroyl peroxide.

In analogous fashion, in the case of a less-preferred bulk polymerization, an additional post-heating step can also be effected after the polymerization reaction proper. In this case, a heat treatment reduces the residual peroxide present to at most 0.375 mmol/kg of polymer. The post-heating is likewise at the same temperature as the polymerization or preferably at a higher temperature.

In terms of the gas phase, there are a number of options for achieving the oxygen content that is to be established in accordance with the invention. For instance, protective gases such as nitrogen or argon may have the appropriate amount of pure oxygen added to them. Preferably, however, air is introduced together with a protective gas in order to achieve the appropriate oxygen concentration. In the case of supplying nitrogen, gas compositions are thus achieved having at least 90% by volume of nitrogen. Should argon be used as protective gas, the gas phase contains at least 12% by volume of argon.

In a further, albeit less preferred, alternative, CO₂ may also be supplied to the reactor or added thereto in the form of dry ice. In this case, the gas phase contains at least 12% by volume of carbon dioxide.

Preferably, the polymer components used are poly(meth)acrylates. Particularly preferably, the polymer used is a suspension polymer.

It has proven to be expedient here when the suspension polymer during the preparation has been initiated with lauroyl peroxide; however, other peroxides are also usable, especially those having similar combinations of decomposition temperature and time.

The monomer component in turn is preferably methacrylates, acrylates or mixtures of methacrylates and/or acrylates. The formulation “(meth)acrylates” used more frequently in the context of this invention here stands as an abbreviation for methacrylates, acrylates or mixtures of methacrylates and/or acrylates. A similar situation applies for the expression poly(meth)acrylates.

The monomers present in the reactive resin are in particular compounds selected from the group of (meth)acrylates such as alkyl (meth)acrylates of straight-chain, branched or cycloaliphatic alcohols having 1 to 40 carbon atoms, for example methyl (meth)acrylate, ethyl (meth)acrylate, n-butyl (meth)acrylate, 2-ethylhexyl (meth)acrylate, stearyl (meth)acrylate, lauryl (meth)acrylate; aryl (meth)acrylates, for example benzyl (meth)acrylate; mono(meth)acrylates of ethers, polyethylene glycols, polypropylene glycols or mixtures thereof having 5 to 80 carbon atoms, such as tetrahydrofurfuryl (meth)acrylate, methoxy(m)ethoxyethyl (meth)acrylate, benzyloxymethyl (meth)acrylate, 1-ethoxybutyl (meth)acrylate, 1-ethoxyethyl (meth)acrylate, ethoxymethyl (meth)acrylate, poly(ethylene glycol) methyl ether (meth)acrylate and poly(propylene glycol) methyl ether (meth)acrylate.

In addition to these (meth)acrylates, the monomer component may also include further unsaturated monomers that are copolymerizable with the abovementioned (meth)acrylates by free-radical polymerization. These include inter alia 1-alkenes or styrenes. Specifically, the proportion and composition of the poly(meth)acrylate is expediently selected with regard to the desired technical function.

Suitable as constituents of the monomer component are also additional monomers having a further functional group, such as α,β-unsaturated mono- or dicarboxylic acids, for example acrylic acid, methacrylic acid, or itaconic acid; esters of acrylic acid or methacrylic acid with dihydric alcohols, for example hydroxyethyl (meth)acrylate or hydroxypropyl (meth)acrylate; acrylamide or methacrylamide; or dirnethylaminoethyl (rneth)acrylate. Examples of further suitable constituents of monomer mixtures are glycidyl (rneth)acrylate or silyl-functional (meth)acrylates.

Preferably, the polymer component and monomer component used in accordance with the invention contain at most 5% by weight of acrylate groups and acrylate repeating units, based on the sum total of acrylate and methacrylate groups. The mixture particularly preferably includes no acrylate groups or acrylate repeating units at all.

The polymer component may have additional functional groups for adhesion promotion, for example in the form of hydroxy groups, or for copolymerization in an optional crosslinking reaction, for example in the form of double bonds. Preferably, however, the polymer component does not have any double bonds.

Particularly preferably, during the mixing a composition is present comprising the following components:
0% by weight to 30% by weight of crosslinkers,
20% by weight to 85% by weight of monomer composition.
0% by weight to 60% by weight of urethane (rneth)acrylates,
10% by weight to 40% by weight of polymer composition,
0% by weight to 5% by weight of additional substances, comprising individual or multiple
substances selected from paraffins, additives, stabilizers, pigments, dyes and/or auxiliaries and
0% by weight, for example at least 1.5% by weight to 10% by weight of accelerators.

Where crosslinkers are present, these are preferably used in a minimum concentration of 0.5% by weight.

In particular, preference is given to a composition comprising the following ingredients:
1.0% by weight to 20% by weight, particularly preferably 1.5% by weight to 15% by weight, of crosslinkers, preferably polyfunctional (meth)acrylates, very particularly preferably di-, tri- or tetra(meth)acrylates.
25% by weight to 75% by weight, particularly preferably 30% to 40% by weight, of (meth)acrylates and/or monomers copolymerizable with (meth)acrylates,
0% by weight to 45% by weight, particularly preferably up to 30% by weight, of urethane (meth)acrylates,
10% by weight to 35% by weight, particularly preferably 15% by weight to 25% by weight, of poly(meth)acrylates,
optionally further auxiliaries and
0.5% by weight to 5% by weight, particularly preferably 2% by weight to 4% by weight, of accelerators.

The accelerator is preferably a tertiary amine or a tertiary organic phosphite. The tertiary amines are generally symmetrical tertiary aromatic amines, as are known from the prior art. Examples of said symmetrical tertiary aromatic amines that may be mentioned include N,N-dimethyl-p-toluidine, N,N-bis(2-hydroxyethyl)-p-toluidine or N,N-bis(2-hydroxypropyl)-p-toluidine.

An optional constituent of the reactive resin according to the invention are crosslinkers. In particular, polyfunctional (meth)acrylates such as allyl (meth)acrylate. Particular preference is given to di- or tri(meth)acrylates such as butane-1,4-diol di(meth)acrylate, poly(urethane) (meth)acrylates, tetraethylene glycol di(meth)acrylate, triethylene glycol di(meth)acrylate or trimethylolpropane tri(meth)acrylate.

The urethane (meth)acrylates optionally present are understood in the context of this invention to be compounds having (meth)acrylate functionalities that are linked together via urethane groups. They are obtainable through the reaction of hydroxyalkyl (meth)acrylates with polyisocyanates and polyoxyalkylenes having at least two hydroxy functionalities. Instead of hydroxyalkyl (meth)acrylates, it is also possible to use esters of (meth)acrylic acid with oxiranes, for example ethylene oxide or propylene oxide, or corresponding oligo- or polyoxiranes. An overview by way of example of urethane (meth)acrylates having a functionality of greater than two is given in DE 199 02 685. A commercially available example prepared from polyols, isocyanates and hydroxy-functional (meth)acrylates is EBECRYL 210-5129 from Allnex. In a reactive resin, urethane (meth)acrylates increase flexibility, breaking strength and elongation at break without relatively major temperature dependence. It has surprisingly been found that with the new curing system even urethane acrylates cure tack-free and without problems in relatively high proportions by weight. This opens up the possibility of largely dispensing with acrylate monomers having typically low glass transition temperatures when preparing flexible reactive resins as are necessary for example for roadway markings or sealing systems.

As is known from the technical field of reactive resins, especially (meth)acrylate resins, it is also possible in this process according to the invention for the polymer component and the monomer component to additionally be mixed with additives and/or auxiliaries, in particular with paraffins, additives, stabilizers and inhibitors, pigments, dyes and/or auxiliaries.

Additives or auxiliaries are understood here to be in particular chain-transfer agents, plasticizers, stabilizers and inhibitors, waxes and/or oils, and also defoamers, rheology additives, wetting, dispersing and levelling auxiliaries. The paraffins are added to prevent inhibition of polymerization by oxygen in the air. It is possible to use for this purpose two or more paraffins having different melting points in different concentrations. It has proven highly favourable when the two-component reactive resin according to the invention additionally contains 0.3% by weight to 3% by weight of one or more paraffins. It is a feature of these paraffins that their solidification point according to DIN ISO 2207 is in the temperature range from 35° C. to 75° C.

As chain-transfer agent, any compounds known from free-radical polymerization can be used. Preference is given to using mercaptans such as n-dodecyl mercaptan. As plasticizers, preference is given to using esters, polyols, oils, low molecular weight polyethers or phthalates.

Wetting, dispersing and levelling auxiliaries are preferably selected from the group of alcohols, hydrocarbons, glycol derivatives, derivatives of glycolic esters, of acetic esters and of polysiloxanes, polyethers, polysiloxanes, polycarboxylic acids, saturated and unsaturated polycarboxylic aminoamides.

Rheology additives used are preferably polyhydroxycarboxamides, urea derivatives, salts of unsaturated carboxylic esters, alkylammonium salts of acidic phosphoric acid derivatives, ketoximes, amine salts of p-toluenesulfonic acid, amine salts of sulfonic acid derivatives, and also aqueous or organic solutions or mixtures of the compounds.

Defoamers are preferably selected from the group of alcohols, hydrocarbons, paraffin-based mineral oils, glycol derivatives, derivatives of glycolic esters, of acetic esters and of polysiloxanes.

UV stabilizers may also be used. The UV stabilizers are preferably selected from the group of benzophenone derivatives, benzotriazole derivatives, thioxanthonate derivatives, piperidinolcarboxylic ester derivatives or cinnamic ester derivatives.

From the group of stabilizers and inhibitors, preference is given to using substituted phenols, hydroquinone derivatives and stabilized radicals, such as for example 4-hydroxy-2,2,6,6-tetramethylpiperidinyloxyl (TEMPOL). In practice, the added amount that can reasonably be used in the reactive resin has an upper limit, since otherwise during curing as intended, especially at low temperatures, there will be incomplete curing. Combinations of two or more different stabilizers may also be used in reactive resins, preference in this case being given to combinations of substituted phenols—preferably in a concentration of between 100 and 1000 ppm—and stabilized free radicals, such as for example TEMPOL—preferably in a concentration of between 15 and 150 ppm.

It has proven highly favourable for some applications when the product of the process according to the invention additionally contains 0.3% by weight to 3% by weight of one or more paraffins. It is a feature of these paraffins that their solidification point according to DIN ISO 2207 is in the temperature range from 35° C. to 75° C.

For various fields of use of the reactive resins prepared in accordance with the invention, such as for example as roadway markings, especially as lines, bars or symbols, or surface markings for identifying, for example, bike paths or bus lanes or parking spaces, colourants are preferably added as auxiliaries and additive substances. Particularly preferred are white, red, blue, green and yellow inorganic pigments, particularly preferred are white pigments such as titanium dioxide.

The reactive resins prepared according to the invention can be used in a wide variety of technical fields. Examples of these are road markings, floor coverings, preferably for industrial applications, for the production of cast components, for sealing or coating roofs, bridges or the joints thereof, especially as sealing membrane, for bridge coating in general, as sealing membrane on roofs, for the production of panels, for example for downstream use as worktop, for the production of protective coatings in particular for metal surfaces, as drainage system resin, for the production of sanitary objects, for the production of adhesives, for filling cracks for example in buildings, or for use in the orthopaedics sector.

### EXAMPLES

The invention shall be explained in more detail below using comparative examples and selected exemplary embodiments.

The residual contents of peroxide in the polymer were determined by high-performance liquid chromatography (HPLC).

Sample preparation: 2.0 g of (meth)acrylate polymer was completely dissolved in 5.0 ml of dichloromethane at room temperature. 70 ml of n-hexane were then added so that (meth)acrylate polymer was precipitated out again. After filtration, the filtrate was dried under reduced pressure. The residue remaining was taken up in cyclohexane and analysed by HPLC.

The stationary phase used in the HPLC was a chemically modified silica gel (C18 column). Detection was by means of UV-VIS detector (220 nm). The HPLC was calibrated and validated using lauroyl peroxide/cyclohexane standard solutions (external standard).

Preparation of Bead Polymer with Adjustment of the Residual Peroxide Content

For preparation of a bead polymer, firstly an aluminium hydroxide Pickering stabilizer solution was prepared analogously to the description of EP 1 219 642 (example 1). A 5 l glass reactor, equipped with Inter-MIG stirrer and reflux condenser, was initially charged with 3200 ml of Pickering stabilizer solution, the stirrer was set to a speed of 300 rpm and the reactor was heated to a jacket temperature of 40° C. 960 g (60% by weight) of n-butyl methacrylate, 640 g (40% by weight) of methyl methacrylate, 8.0 g of lauroyl peroxide and 12.30 g of 2-ethylhexyl thioglycolate were mixed in a glass beaker and homogenized with stirring. This monomer stock solution was pumped into the reactor and polymerized for 110 minutes (polymerization duration) with stirring at a reactor internal temperature of 76° C. (polymerization temperature).

Following the polymerization, the suspension polymers obtained were thermally after treated, as shown in the following table. Various residual contents of lauroyl peroxide in the bead polymer could be established via the length of time and the temperature level of the thermal aftertreatment.

| Batch for | Temperature of | Duration | Residual content |
|---|---|---|---|
| preparation of | thermal | of thermal | of lauroyl |
| bead polymer | aftertreatment | aftertreatment | peroxide |
| 1 | 85° C. | 80 min | 200 ppm |
| 2 | 87° C. | 120 min | 80 ppm |
| 3 | 85° C. | 60 min | 250 ppm |

Each batch was then cooled to 45° C. and the stabilizer was subsequently converted into water-soluble aluminium sulfate by addition of 50% sulfuric acid. The mother liquor was separated from the polymer beads on a suction filter, washing was performed with demineralized water and the polymer beads were dried in a fluidized bed dryer at an air feed temperature of 70° C. to a residual moisture content of approx. 0.5% by weight.

### Comparative Example 1

A 2000 ml jacketed glass reactor, which was equipped with a reflux condenser and a mechanical stirrer (anchor) and had multiple inlets and a gas feed, was charged with 515.1 g of methyl methacrylate (stabilized with 5 ppm of 2,6-di-tert-butyl-4-methylphenol), 510.0 g of n-butyl acrylate (stabilized with 5 ppm of 2,6-di-tert-butyl-4-methylphenol), 40.0 g of triethylene glycol dimethacrylate (stabilized with 250 ppm of 2,6-di-tert-butyl-4-methylphenol), 0.900 g of 2,6-di-tert-butyl-4-methylphenol, 20.0 g of Sasol wax 5603 (an olefin wax) and 14.0 g of N,N-bis(2-hydroxypropyl)-p-toluidine and the mixture was stirred.

The reactor was then purged with a gas mixture consisting of 96% nitrogen and 4% oxygen and blanketed with the gas mixture.

Thereafter, 400.0 g of bead polymer having a specific residual content of 200 ppm by weight of lauroyl peroxide, corresponding to 050 mmol of lauroyl peroxide per kilogram of bead polymer, were added while stirring vigorously. The jacket was then heated with 60° C. warm water until a temperature of the added components of 55° C. had been reached. Stirring was continued until all constituents had dissolved, which was the case approx. 75 min after addition of the bead polymer. The resin was then cooled to 23° C. with stirring.

### Example 1

A 2000 ml jacketed glass reactor, which was equipped with a reflux condenser and a mechanical stirrer (anchor) and had multiple inlets and a gas feed, was charged with 515.1 g of methyl methacrylate (stabilized with 5 ppm of 2,6-di-tert-butyl-4-methylphenol), 510.0 g of n-butyl acrylate (stabilized with 5 ppm of 2,6-di-tert-butyl-4-methylphenol), 40.0 g of triethylene glycol dimethacrylate (stabilized with 250 ppm of 2,6-di-tert-butyl-4-methylphenol), 0.900 g of 2,6-di-tert-butyl-4-methylphenol, 20.0 g of Sasol wax 5603 (an olefin wax) and 14.0 g of N,N-bis(2-hydroxypropyl)-p-toluidine and the mixture was stirred.

The reactor was then purged with a gas mixture consisting of 96% nitrogen and 4% oxygen and blanketed with the gas mixture.

Thereafter, 400.0 g of bead polymer having a specific residual content of 80 ppm by weight of lauroyl peroxide, corresponding to 0.20 mmol of lauroyl peroxide per kilogram of bead polymer, were added while stirring vigorously. The jacket was then heated with 60° C. warm water until a temperature of the added components of 55° C. had been reached. Stirring was continued until all constituents had dissolved, which was the case approx. 75 min after addition of the bead polymer. The resin was then cooled to 23° C. with stirring.

### Comparison of the Storage Stability at 90° C. of the Resins from Comparative Example 1 and Example 1

To test the storage stability, 90 ml of the methacrylate resins prepared were introduced in each case into 100 ml glass bottles. The glass bottles were closed and stored in a heating cabinet at 90° C. The stability of the methacrylate resins was visually inspected several times a day.

TABLE 1
Results for storage stability at 90° C.

| | Storage stability |
|---|---|
| Example | at 90° C. |
| Comparative Example 1 | <1 day |
| Example 1 | 5 days |

When comparing the results, the substantially higher storage stability of Example 1 of the invention is clearly visible even in purely visual terms.

### Comparative Example 2

A 2000 ml jacketed glass reactor, which was equipped with a reflux condenser and a mechanical stirrer (anchor) and had multiple inlets and a gas feed, was charged with 515.1 g of methyl methacrylate (stabilized with 5 ppm of 2,6-di-tert-butyl-4-methylphenol), 510.0 g of n-butyl acrylate (stabilized with 5 ppm of 2,6-di-tert-butyl-4-methylphenol), 40.0 g of triethylene glycol dimethacrylate (stabilized with 250 ppm of 2,6-di-tert-butyl-4-methylphenol), 0.900 g of 2,6-di-tert-butyl-4-methylphenol, 20.0 g of Sasol wax 5603 (an olefin wax) and 14.0 g of N,N-bis(2-hydroxypropyl)-p-toluidine and the mixture was stirred.

The reactor was then purged and blanketed with nitrogen.

Hereafter, 400.0 g of bead polymer having a specific residual content of 250 ppm by weight of lauroyl peroxide, corresponding to 0.63 mmol of lauroyl peroxide per kilogram of bead polymer, were added while stirring vigorously. The jacket was then heated with 60° C. warm water until the temperature of the added components had risen to 55° C. After 45 min of stirring time after addition of the bead polymer, polymerization of the contents of the reactor occurred, which was visible as an intense rise in viscosity, especially through formation of gel-like constituents.

### Comparative Example 3

A 2000 ml jacketed glass reactor, which was equipped with a reflux condenser and a mechanical stirrer (anchor) and had multiple inlets and a gas feed, was charged with 515.1 g of methyl methacrylate (stabilized with 5 ppm of 2,6-di-tert-butyl-4-methylphenol), 510.0 g of n-butyl acrylate (stabilized with 5 ppm of 2,6-di-tert-butyl-4-methylphenol), 40.0 g of triethylene glycol dimethacrylate (stabilized with 250 ppm of 2,6-di-tert-butyl-4-methylphenol), 0.900 g of 2,6-di-tert-butyl-4-methylphenol, 20.0 g of Sasol wax 5603 (an olefin wax) and 14.0 g of N,N-bis(2-hydroxypropyl)-p-toluidine and the mixture was stirred.

The reactor was then purged and blanketed with nitrogen.

Thereafter, 400.0 g of bead polymer having a specific residual content of 80 ppm by weight of lauroyl peroxide, corresponding to 0.20 mmol of lauroyl peroxide per kilogram of bead polymer, were added while stirring vigorously. Thereafter the jacket was heated with 60° C. warm water until the temperature of the added components had risen to 55° C. After 120 min of stirring time after addition of the bead polymer, polymerization of the contents of the reactor occurred, which was visible as an intense rise in viscosity, especially through formation of gel-like constituents.

TABLE 2
Comparison of the production of reactive
resin with nitrogen blanketing

| | Time until |
|---|---|
| Example | polymerization |
| Comparative Example 2 | 45 min |
| Comparative Example 3 | 120 min |

When comparing the results, it is clear that Comparative Example 3 has substantially longer time until polymerization during resin preparation under nitrogen. Despite this, it is found that a minimum proportion of oxygen during the preparation of the reactive resin is important.

1: A process for preparing storage-stable (meth)acrylate-based reactive resins, the process comprising:
mixing at least one polymer component and a monomer component with one another under a gas phase with stirring, with at least 90% by weight of the at least one polymer component dissolving in the monomer component,
that wherein the gas phase has an oxygen content of between 3% and 8% by volume, and wherein the at least one polymer component prior to mixing with the monomer component has a residual peroxide content of at most 0.375 mmol of peroxide per kilogram.

2: The process according to claim 1, wherein the residual peroxide content in the at least one polymer component prior to mixing is at most 0.25 mmol of peroxide per kilogram.

3: The process according to claim 1, wherein the at least one polymer component is a poly(meth)acrylate.

4: The process according to claim 1, wherein the at least one polymer component is a suspension polymer.

5: The process according to claim 4, wherein during preparation the suspension polymer was initiated with lauroyl peroxide.

6: The process according to claim 1, wherein the monomer component is selected from the group consisting of methacrylates, acrylates, and mixtures of methacrylates and/or acrylates.

7: The process according to claim 1, wherein the at least one polymer component and the monomer component are additionally mixed with paraffins, additives, stabilizers, pigments, dyes, and/or auxiliaries.

8: The process according to claim 1, wherein the gas phase includes at least 90% by volume of nitrogen.

9: The process according to claim 1, wherein the gas phase includes at least 12% by volume of argon and/or carbon dioxide.

10: The process according to claim 1, wherein the at least one polymer component and the monomer component contain at most 5% b weight of acrylate groups and acrylate repeating units, based on a sum total of acrylate and methacrylate groups.

11: The process according to claim 1, wherein during the mixing a composition is present containing
0% by weight to 30% by weight of crosslinkers,
20% by weight to 85% by weight of monomer composition,
0% by weight to 60% by weight of urethane (meth)acrylates,
10% by weight to 40% by weight of polymer composition,
0% by weight to 5% by weight of additional substances, comprising individual or multiple substances selected from the group consisting of paraffins, additives, stabilizers, pigments, dyes, auxiliaries, and
0% by weight to 10% by weight of an accelerator.

12: The process according to claim 11, wherein the accelerator is a tertiary amine or a tertiary organic phosphite.
